(19) United States
(12) Patent Application Publication
(10) Pub. No.: US 2023/0257199 A1
(43) Pub. Date: Aug. 17, 2023

(54) MOBILE AUTONOMOUS ROBOT FOR ORDER PICKING AND ORDER PICKING METHOD

(71) Applicant: IFOLLOW, MEUDON (FR)

(72) Inventors: Vincent Jacquemart, MEUDON (FR); Nicolas Menigoz, PARIS (FR)

(21) Appl. No.: 18/004,770

(22) PCT Filed: Jul. 8, 2021
(86) PCT No.: PCT/EP2021/068944

§ 371 Date: Jan. 9, 2023

(30) Foreign Application Priority Data
Jul. 10, 2020 (FR) FR2007360

(51) Int. Cl. B65G 1/137; B25J 9/00

(52) U.S. Cl. CPC B65G 1/1373; B25J 9/0009

(57) ABSTRACT

A mobile autonomous robot for picking orders for products stored in a warehouse. The robot includes a receiving device for receiving at least two movable order-picking holders for the products, referred to as picking holders, and an independent retainer for retaining each of the at least two picking holders on the mobile autonomous robot.

### FIELD OF THE INVENTION

The field of the invention is that of logistics, in particular for order picking in a warehouse storing products to be dispatched.

The present invention relates in particular to assistance for order picking by means of autonomous robots (referred to as “Autonomous Mobile Robots—AMRs”), and more particularly the picking abilities of such autonomous robots for optimising order picking.

### PRIOR ART

The logistics field has been developing continuously for many years. With regard to order picking in particular, the technical and technological developments have been numerous, ranging from management software to product conveyors through smart storage racks.

We are concerned here more particularly with the order picking implemented by operators and assisted by autonomous robots. Thus, the operators and the robots cooperate in the same work space in order to pick, in an optimum manner, the various orders that are received by the order management system of the warehouse.

Conventionally, an operator is responsible for taking the various products of an order at the various locations of the warehouse and depositing them on the autonomous robot that accompanies him.

To do this, the autonomous mobile robot 1 is provided for example with a picking holder 3 for receiving the products deposited by the operator, as illustrated in FIG. 1a.

In order to increase the efficiency of order picking, this picking holder 3 can for example have a plurality of sets of shelves 31, 32 (FIG. 1b), so as to allow the picking of various orders.

However, the order picking field is a very competitive field and continuously searching for solutions for improving the efficiency of order picking, in particular by reducing the movements of the operators and autonomous mobile robots, as well as by optimising each of the steps in the logistic chain.

There is therefore a need to provide a novel approach that can adapt in real time to the various constraints of order picking while optimising the overall efficiency of the system, i.e. the efficiency of the operators and of the robots.

### SUMMARY OF THE INVENTION

The present invention proposes a technical solution for optimising the overall efficiency of the system picking by means of an autonomous mobile robot for order picking of products stored in a warehouse, comprising a device receiving at least two movable picking holders for said products, referred to as picking holders, and independent means for retaining each of the at least two picking holders on the autonomous mobile robot.

Thus the present invention proposes a novel and inventive solution for order picking implemented by autonomous mobile robots in a warehouse, making it possible to greatly increase the productivity of order picking. To do this, the autonomous mobile robots are adapted to order picking of products stored in a warehouse, i.e. they have specific features such as, in particular:
abilities to communicate with other robots in the same fleet and with a supervision system responsible for managing a fleet of robots, for the purpose of optimising order picking in a warehouse;
ease of movement in warehouse aisles, in which other robots travel as well as order pickers;
endurance for being able to prepare the largest number of orders without having to be recharged;
compactness and in particular thinness, for example for being able to slide under elements to be transported.

In addition, according to the present technique, such autonomous mobile robots are designed to be able to carry and therefore move at least two product picking holders, thus making it possible for example to pick two separate orders directly in two separate containers.

The solution proposed therefore makes it possible to avoid any subsequent handling of the products of different orders, at the moment of finalisation of these orders. This is because the respective products of each order are already grouped together in a container, the latter being able to be directly used for transporting the order (for example loaded into a lorry).

The order picking is therefore optimised:
in terms of number of pickers necessary: no picker is required for distributing the products of several orders that would have been collected in the same container,
in terms of picking time: the manipulations of the products are limited, the picking being able to be selective thanks to the plurality of containers on the same autonomous mobile robot. The number of pickings made by an operator is increased while limiting the movements of this operator,
in terms of error rate in an order: the risks of erroneous attribution of products to an order are limited because of the selective picking and the limitation of manipulations of products.

The present solution also allows the picking of frozen products in a specific refrigerated container at the same time as the picking of non-frozen products in a second, conventional, container, on the same autonomous mobile robot.

The picking holders are specific to the picking of orders and are in particular themselves movable, for example via wheels, so as to be able to be used for transporting products, directly at the end of order picking. Such product picking holders correspond for example to high mesh cages, on wheels.

Finally, holding means are provided for independently holding each product picking holder on the autonomous mobile robot. Thus, the product picking holders can be loaded onto or unloaded from the autonomous mobile robot also independently.

According to a particular aspect, the reception device is adaptable to the picking holders.

Thus, according to this embodiment, an autonomous mobile robot can receive any type of product picking holder by means of a reception device adaptable according to the type of holder. For example, the robots in a fleet of robots in an order picking warehouse can be adapted to the type of holder used in the warehouse, or more specifically still to the type of holder used for a customer, etc.

Adapting the reception device to various types of holder means for example in terms of size, to receive holders of different sizes, in terms of shape to receive holders with different shapes, or in terms of strength, to receive holders with different weights.

For example, the reception device is removable.

Thus, according to this embodiment, the adaptability of the reception device to any type of product picking holder is implemented via removable reception devices, for example by means of a system for attaching to the robot adaptable to any type of reception device, and having different characteristics.

In this way, it is just needed to select the reception device adapted to the product picking holder used and to attach it to the robot, and, when the product picking holder changes, it is just needed to remove the reception device and to replace it with another device adapted to the new product picking holder.

According to another aspect, the reception device has a modifiable structure to adapt to the picking holders.

Thus, according to this embodiment, the adaptability of the reception device to any type of product picking holder is implemented via a modifiable structure of the reception device itself. For example, the dimensions of the reception device can be modified by sliding systems of structure elements, thus making it possible to receive product picking holders of different sizes while correctly retaining them. Likewise, systems for reinforcing the structure of the reception device can be added to the device to receive heavier product picking holders or ones intended to be heavily loaded, etc.

According to a particular feature, the retaining means are carried by the reception device.

Thus, the means for retaining the product picking holders are part of the device for receiving these product picking holders on the robot, thus also allowing adaptability of the holding means to any type of product picking holder. In this way, the product picking holders are always maintained optimally on the autonomous mobile robot when the latter moves and when products are deposited in the product picking holders.

For example, the retaining means are in the form of:
a magnetic system cooperating with the picking holders; a magnet can be provided on the reception device so as to exert a retaining force on the metal picking holders. If these picking holders are not metal, they can have a metal part or a complementary magnet for ensuring retaining of the holder on the reception device of the autonomous mobile robot;
a mechanical system corresponding to protrusions or tongues for retaining the picking holders; the reception device may have higher ridges at certain points, or simply kinds of retaining tongues, making it possible mechanically to retain the holders on the reception device of the autonomous mobile robot;
a mechanical locking system cooperating with a part of the picking holders, such as for example a cam locking system.

According to a particular feature, the reception device corresponds to a tubular structure or to a solid structure secured removably to said robot.

Thus, according to this embodiment, a kind of low basket/small cage, sized to receive at least two product picking holders, is attached to the robot removably.

Such a structure can be metallic or made from plastics material, and have a strength adapted to the weight of at least two product picking holders, including when they are loaded with picked products.

In addition, such a structure has a low height in order not to increase the height of access to the holders to deposit therein the picked products and therefore to maintain an optimum level of ergonomics for the order pickers.

Such a structure can also be designed so that its dimensions can be adapted (for example via systems for sliding metal tubes that can therefore be extended or shortened) or so that some parts can be reinforced (for example via solid structures that can be added on the sides of the metal structure).

According to a particular feature, the autonomous mobile robot comprises a module for detecting the depositing of at least one product in at least one of said movable picking holders. This detection module makes it possible not only to detect when a product is deposited in a picking holder, but it makes it possible to determine whether it is the expected product that has been deposited and whether it has been deposited in the correct picking holder. This is because the presence of a plurality of picking holders on the same robot gives rise to a risk of depositing error for a picker. This detachment module thus makes it possible to check the products deposited automatically, without the picker having any actions to implement.

The present technique also relates to a method for picking orders of products stored in a warehouse by at least one autonomous mobile robot as described above, according to the various embodiments.

Such a method comprises the following steps:
depositing, by an order picker, at least one product of a first order in at least one first movable product picking holder carried by at least one autonomous mobile robot;
depositing, by an order picker, at least one product of a second order in at least one second movable product picking holder carried by the autonomous mobile robot.

Thus, according to this embodiment, the number of product pickings per hour implemented by an operator is greatly increased, while greatly reducing the movements of the operators and robots.

According to a particular aspect, the method comprises a step, implemented by the autonomous mobile robot, for detecting the depositing of at least one product in at least one of the movable picking holders. This step thus makes it possible to check the depositing of the products automatically, without the picker having to do it or to communicate data validating these picking and depositing actions.

### LIST OF FIGURES

The technique proposed, as well as the various advantages that it presents, will be understood more easily in the light of the following description of several illustrative and non-limitative embodiments thereof, and the accompanying drawings, among which:

FIG. 1a illustrates an autonomous mobile robot according to a technique of the prior art;

FIG. 1b illustrates a picking holder according to a technique of the prior art;

FIG. 2a illustrates an autonomous mobile robot according to an embodiment of the present technique;

FIG. 2b illustrates an autonomous mobile robot according to another embodiment of the present technique;

FIG. 3 illustrates an autonomous mobile robot with two picking holders, according to an embodiment of the present technique;

FIG. 4 illustrates the main steps of the order picking method according to an embodiment of the present technique;

FIG. 5 illustrates an autonomous mobile robot with three picking holders, according to another embodiment of the present technique.

### DETAILED DESCRIPTION OF THE INVENTION

### A—General Principle of the Technique Proposed

The general principle of the technique proposed consists in optimising the movements of the picking operators, or order pickers, and of the autonomous mobile picking robots in a warehouse storing products to be dispatched in order to maximise the use/efficiency thereof. By improving the efficiency of the operators and robots, a larger number of orders can be implemented per unit of time (for example per hour).

To do this, the technique proposed provides that an autonomous mobile robot can carry at least two picking holders, in which a picker deposits the products picked, unlike the known techniques according to which a robot moves only a picking cart.

Thus, according to the present technique, a picker can pick two separate orders directly in two separate holders, which makes the finalisation of the orders more effective. This is because no additional handling is required when the robot has ended its picking, the products of different orders being directly stored separately on the various picking holders.

In addition, the present technique also allows the use of movable picking holders, i.e. ones that can easily be manipulated by an operator when they are no longer on a mobile robot. Thus, when an order is finished, the picking holder can for example be directly conveyed, by an operator, to the transport vehicle/lorry to be loaded thereon, without the operator having to carry the holder. For example, it is a picking holder having wheels.

### B—Description of an Embodiment

The known autonomous mobile robots are therefore not designed to carry more than one picking holder. The present invention therefore affords compatibility with the current autonomous mobile robots by virtue of the use of a reception device on the robot for being able to carry at least two movable picking holders.

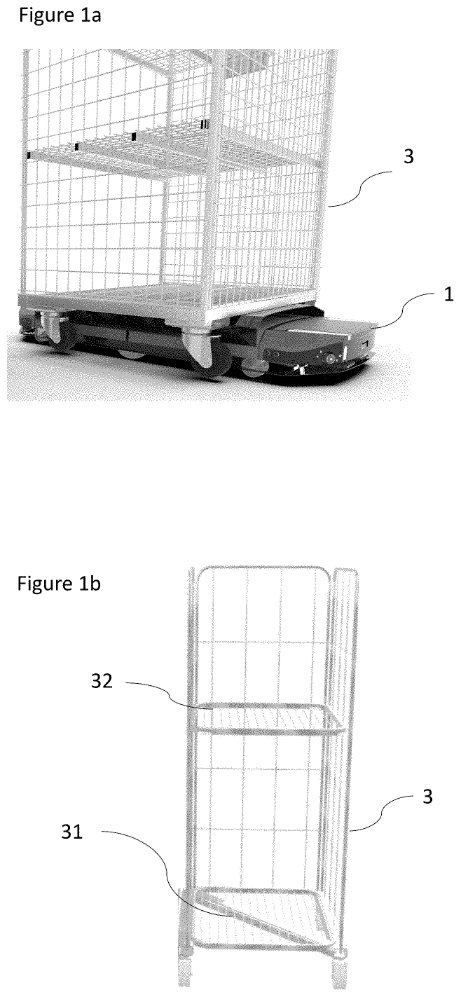

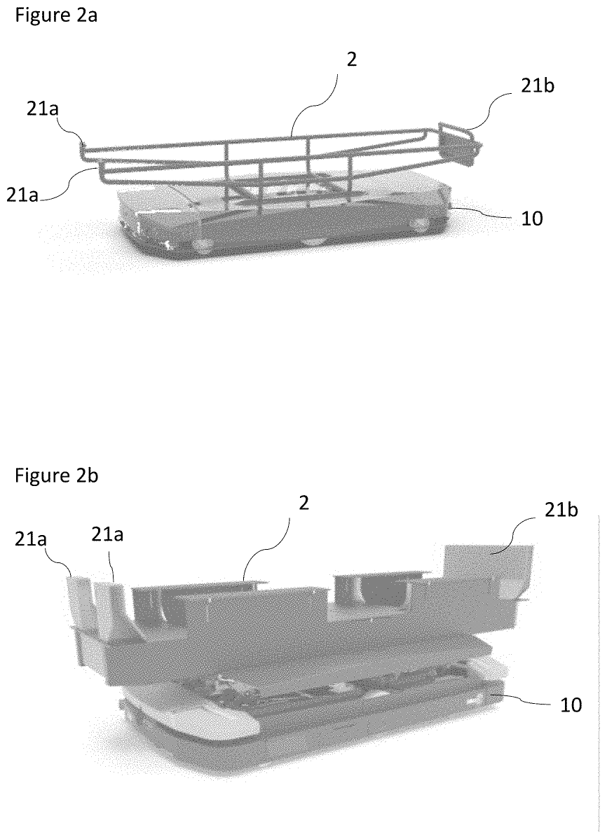

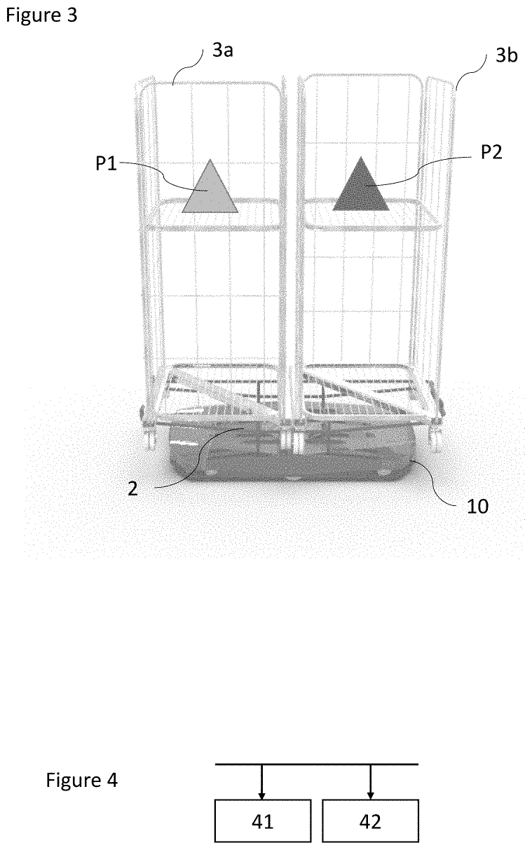

As illustrated in FIGS. 2a, 2b and 3, an autonomous mobile robot 10 therefore comprises a device 2 for receiving at least two movable picking holders 3a and 3b. For example, these movable picking holders are of the type illustrated in FIG. 1b, namely a kind of mesh set of shelves with wheels enabling it to be moved autonomously also. The reception device equipping an autonomous mobile robot therefore also ensures compatibility with known movable picking holders.

This is because such movable picking holders are particularly adapted to picking orders for products stored in a warehouse, in particular because of their autonomous mobility and on an autonomous mobile robot. Thus it is possible to convey them and to load them directly into a transport vehicle, once the orders are picked.

However, because in particular of the intrinsic mobility of these picking holders, it is necessary to provide a device for accommodating these holders on the autonomous mobile robot. This is because it is necessary firstly for the robot to be able to carry more than one movable picking holder and secondly for the holders carried by the autonomous mobile robot to be retained in place during the movement of the robot.

As illustrated on FIGS. 2a and 2b, this reception device 2 is slightly longer than the robot 10, thus making it possible to carry two movable picking holders positioned side by side.

In addition, in order to ensure the holding of the two movable picking holders on the robot, the latter also comprises independent means 21a, 21b for retaining each of the two picking holders.

Thus, according to a first embodiment illustrated on FIGS. 2a and 2b, first holding means 21a are provided at one end of the movable picking holder, to retain a first retaining 3a (FIG. 3), and a second retaining means 21b is provided at the other end of the movable picking holder, to retain a first holder 3b (FIG. 3).

According to this embodiment, the retaining means 21a and 21b are carried by the reception device 2 itself, for example in the form of protrusions or tongues making it possible to retain the movable picking holders when they are carried by the autonomous mobile robot.

According to other embodiments, not illustrated, the retaining means can take the form of a magnetic system cooperating with the picking holders, for example when these holders are metal or when they have a magnetic system cooperating with the one provided on the autonomous mobile robot, or the reception device.

The retaining means can also be in the form of a mechanical locking system (carried by the reception device or the robot itself) cooperating with a part of the picking holders, such as for example a cam or a kind of bolt adapted to the form of the picking holders carried by the robot.

The retaining means are designed to hold the two picking holders when the robot moves and in particular when the robot brakes and restarts, or, where applicable, in the event of collision with another robot or impact with an obstacle on the travel of the robot.

Moreover, the technique proposed also allows adaptability of the autonomous mobile robots to all types of picking holder, either because the reception device is removable and therefore interchangeable according to the type of holder, or because the reception device itself has a modifiable structure enabling adaptation to the type of holder.

Thus, according to a first variant, a plurality of reception devices, with different shapes and sizes, are designed so as to be able to adapt to the various types of picking holder. For example, reception devices can be manufactured specially to adapt to picking holders used in a warehouse. Likewise, it is possible to equip a fleet of autonomous mobile robots with new reception devices adapted to new picking holders that would come to be used. This variant and the removable character of the reception devices therefore allow optimum adaptability both for the robots and for the picking holders.

According to a second variant, a reception device is designed so as to be able itself to adapt to various types of picking holder, i.e. it can be elongated or shortened, in all the dimensions, by virtue of adjustment systems.

For example, when the reception device corresponds to a tubular metal structure, its dimensions can be modified via systems for sliding the tubes that make it up. This variant allows a more reactive adaptability to a change of the picking holder type, which does not require changing the reception device itself.

FIGS. 2a and 3 illustrate an example of a reception device 2 in the form of a metal tubular structure making it possible to receive two picking holders retained by tongues at these two ends. Such a form makes it possible to obtain a reception device that is lightweight and compact, increasing only very little the load on the robot on which it is installed.

According to another embodiment illustrated in FIG. 2b, a reception device 2 can be in the form of a solid non-tubular structure, metal or made from plastics material.

The selection of the form and of the material of the reception device can be guided by considerations of strength, since the picking holders may be very heavy at the end of the picking of an order, or according to the type of robot and picking support used.

Moreover, because of the presence of a plurality of movable picking holders on one and the same robot, the risks of errors in depositing products by the pickers are a little more increased. Thus, a picker may mistake the picking holder for depositing a product that has been taken. A conventional solution would be asking the picker to validate each deposit of a product, for example via the mobile terminal that he uses for managing his order picking (for scanning the products in particular).

The present technique proposes a novel and inventive solution via a module for detecting the depositing of at least one product in at least one of the movable picking holders, making it possible:
to know precisely where the picker is depositing the product on the robot: on the “front” holder 3a or on the “rear” holder 3b;
to know the number of packages/products deposited, on each holder;
to make a weight check via a comparison of the weight of the product deposited with the known theoretical weight of the product expected.

This solution therefore avoids the order picker making a check on the product deposited and a confirmation of the conformity of the deposit, for each picking, thus increasing its efficiency while optimising the quality of the order picking.

The module for detecting the depositing is based on a scales system, for example a balance, in communication with a task manager integrated in the robot, making it possible in particular to know the number of items of stock expected, the type thereof and the theoretical weight thereof, in real time, at any moment of the order picking.

The detection module can be integrated in the autonomous mobile robot or attached to the autonomous mobile robot, i.e. positioned on the autonomous mobile robot and connected to the latter via communication links.

### C—Order Picking Method

The present technique also concerns an order-picking method assisted by at least one robot as described previously, according to the various embodiments and the various variants.

This is because, if using autonomous mobile robots for assisting the order pickers is known, the solution described previously makes it possible to optimise the order picking by using robots able to move at least two movable picking holders. Such robots therefore make it possible for a picker to deposit at least one product P1 of a first order in at least one first movable picking holder 3a carried by the autonomous mobile robot 10 that is assisting him and at least one product P2 of a second order in at least a second mobile picking holder 3b carried by the same autonomous mobile robot 10.

In this way, the number of pickings per hour, for an order picker, is greatly increased since he can deposit the items of stock in a larger number of picking holders.

This also makes it possible to pick separately two orders at the same time, by depositing the products of each order in the appointed picking holder. In this way, at the end of the picking of two orders, there is no additional handling of the stock to be made, i.e. no distribution or dispatch of the products of a plurality of orders that would be deposited in the same holder as in the known techniques of the prior art.

Moreover, according to a particular embodiment, the order picking method comprises a step, implemented by the autonomous mobile robot, of detecting the depositing of at least one product in at least one of the movable picking holders. This detection step is implemented for example by a detection module, integrated in or connected to the autonomous mobile robot, in communication with the task manager of the robot. In this way, checking the depositing of a product in the correct movable picking holder on the robot is done automatically, without requiring any specific action by the order picker himself, thus increasing the quality of the orders by limiting errors while not slowing down the picker in his tasks of taking and depositing the products.

### D—Other Features

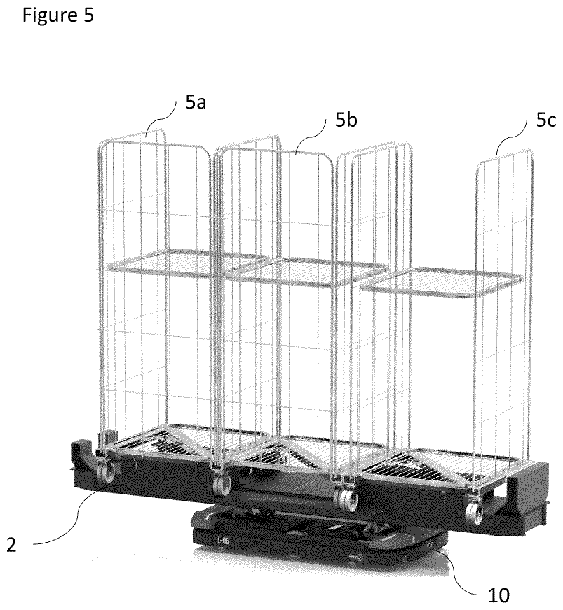

The embodiments, variants and examples described above are not limitative in terms of number of movable picking holders that can be moved by a single autonomous mobile robot. This is because, according to the size of the robot and of the movable picking holders, the reception device is adapted for being able to accommodate at least two movable picking holders; it can therefore be envisaged that a robot can for example move three or four movable picking holders. An example of an autonomous mobile robot 10 carrying three movable picking holders 5a, 5b and 5c is illustrated in FIG. 5. The reception device 2 is therefore adapted to receive three picking holders, and is therefore in particular much longer than for two picking holders.

The adaptability of the reception device equipping an autonomous mobile robot affords optimum compatibility with existing and future robots, existing and future picking holders, and the number of picking holders that can be carried by a robot.

1. An autonomous mobile robot for picking orders of products stored in a warehouse, wherein the autonomous mobile robot comprises:
a reception device configured to receive at least two movable picking holders for said products, referred to as picking holders; and
at least two independent retainers, each independent retainer being configured to retain a respective one of said at least two picking holders on said autonomous mobile robot.

2. The autonomous mobile robot for picking orders according to claim 1, wherein said reception device is adaptable to said picking holders.

3. The autonomous mobile robot for picking orders according to claim 1, wherein said reception device is removable.

4. The autonomous mobile robot for picking orders according to claim 1, wherein said reception device has a modifiable structure for adapting to said picking holders.

5. The autonomous mobile robot for picking orders according to claim 1, wherein said at least two independent retainers are carried by said reception device.

6. The autonomous mobile robot for picking orders according to claim 1, wherein said at least two independent retainers are in the form of:
a magnetic system cooperating with said picking holders;
a mechanical system corresponding to retaining protrusions or tongues of said picking holders; or
a mechanical locking system cooperating with a part of said picking holders.

7. The autonomous mobile robot for picking orders according to claim 1, wherein said reception device comprises a tubular or solid structure removably secured to said robot.

8. The autonomous mobile robot for picking orders according to claim 1, comprising a detection module configured to detect a depositing of at least one product in at least one of said movable picking holders.

9. A method for preparing orders for products stored in a warehouse by at least one autonomous mobile robot, the autonomous mobile robot comprising:
a reception device configured to receive at least two movable picking holders for said products, referred to as picking holders; and
at least two independent retainers, each independent retainer being configured to retain a respective one of said at least two picking holders on said autonomous mobile robot,
wherein the method comprises:
depositing, by an order picker, at least one product of a first order in at least one first of the movable product picking holders carried by said at least one autonomous mobile robot; and
depositing, by an order picker, at least one product of a second order in at least one second of the movable product picking holders carried by said at least one autonomous mobile robot.

10. The method for preparing orders according to claim 9, comprising said autonomous mobile robot detecting the depositing at least one product in at least one of said movable picking holders.
